(19) United States
(12) Patent Application Publication
(10) Pub. No.: US 2016/0098663 A1
(43) Pub. Date: Apr. 7, 2016

(54) AGENT QUALITY AND PERFORMANCE MONITORING BASED ON NON-PRIMARY SKILL EVALUATION

(71) Applicant: Avaya Inc., Santa Clara, CA (US)

(72) Inventors: David Skiba, Golden, CO (US); Valentine C. Matula, Granville, OH (US); George Erhart, Loveland, CO (US)

(21) Appl. No.: 14/507,127

(22) Filed: Oct. 6, 2014

(51) Int. Cl. G06Q 10/06; G06Q 10/10

(52) U.S. Cl. CPC G06Q 10/06393; G06Q 10/105

(57) ABSTRACT

Contact centers continually monitor the performance of their resources (e.g., human and automated agents) used for processing work items. An agent with a primary skill receives a flow of work items each having an attribute associated with that particular primary skill. However, agents often have non-primary skills and may serve as a backup for other agents. Measuring the agent's skill level with respect to a non-primary skill allows agents to be scored and potentially identified as having the skill as a primary skill. Selectively providing agents with non-primary work items and monitoring the agent's performance with those work items provides a means to assess an agent's non-primary skill using real work items and without the need for testing resources.

### CROSS REFERENCE TO RELATED APPLICATIONS

This application claims the benefit of U.S. patent application Ser. No. ______ filed Oct. 6, 2014, entitled “AGENT NON-PRIMARY SKILL IMPROVEMENT TRAINING METHOD”, Sheridan Ross Docket No. 4366-683, the entire disclosure of which is incorporated herein by reference.

### FIELD OF THE DISCLOSURE

The present disclosure is generally directed toward automatic measurement of a skill

### BACKGROUND

Contact center agents are almost always being graded on performance. Useful monitoring programs for agents should include consistency, fairness, and impartiality in grading. It is often difficult to provide a framework that contains the elements of a good monitoring program when supervisors have to manually evaluate performance through by listening to agents' conversations in real-time or by reviewing recorded interactions. Often the calls chosen for monitoring are just a small sample of work items an agent has processed.

Automation has been introduced to provide evaluation with less bias, including agent self-rating, customer surveys, and script adherence monitoring. Unfortunately, these solutions only consider a small sampling and limited portions of a work item.

Agents of a contact center generally have at least one primary skills and may have one or more non-primary skills. Contact centers may prefer to route work items, having an attribute associated with a particular skill, to a primary agent (e.g., an agent having that particular skill as a primary skill). For Example, if a work item is a call and the attribute is “French,” routing the call to an agent who is fluent in French (e.g., has “French” as a primary skill) may be preferred over routing the call to someone who is merely familiar with French (e.g., has “French” as a non-primary skill).

Work items may still be routed to non-primary agents due to unavailability of primary agents, load balancing, or other issues or objectives. For example, an agent having French as a non-primary skill may have a primary skill (e.g., technical expertise, product expertise, etc.) that warrants routing the call to that agent, even if the lack of fluency presents some difficulties. Routing calls to agents without at least minimal proficiency is generally undesirable if the attribute would not provide at least some possibility to successfully processing the work item. For example, routing a call from a French-only customer to an agent that has no understanding of French would obviously be avoided.

### SUMMARY

It is with respect to the above issues and other problems that the embodiments presented herein were contemplated. Disclosed herein with respect to certain embodiments, agent quality and performance monitoring is performed based on the evaluation of an agent's non-primary skill.

In one embodiment, routing of work items to agents of a contact center is used, at least in part, for performance evaluation purposes with respect to a non-primary skill. Work items having an attribute associated with the skill are routed to a non-primary agent for skill monitoring in real-time and/or at a later time. Agent quality and performance monitoring, as disclosed herein, can be performed based on a need for non-primary skill evaluation. For example, an agent may be selected for review of a non-primary skill to determine if the skill can be added to the agent's list of primary skills or an agent's non-primary skill may be determined to be at one point on a scale and confirmation, or movement to a different point on the scale, may be determined.

One benefit provided by the embodiments disclosed herein is the measurement of a human agent's non-primary skill with respect to voice conversations with a customer of the contact center. However, it would be appreciated by those of ordinary skill in the art that non-voice work items (e.g., video, text chat, email, social media, co-browse, etc.) and non-human agents (e.g., interactive voice response (IVR), etc.) may also be utilized for evaluation without departing from the scope of the embodiments disclosed herein.

Similarly, the disclosure provided herein is directed primarily towards the evaluation of non-primary skill of an agent. While certain embodiments may be applied to evaluate a primary skill, other systems and techniques are often better suited to evaluate such skills. Similarly, the evaluation techniques of primary skills, when applied to non-primary skills, may produce a result but such results are likely to produce a heavily skewed picture that is erroneous or unusable. For example, an agent who has Spanish as a primary skill would generally be measured with respect to other aspects of a work item (e.g., speed, technical competence, product familiarity, etc.). Another agent who has Spanish as a non-primary skill, and has only limited Spanish abilities, but is measured as without regard to Spanish being a non-primary skill may be determined to have handled a call poorly or have other skills that are wanting. For example, the agent may take a longer time to process the call or ask the customer to repeat themselves too often. Without considering Spanish is a non-primary skill, the agent may be erroneously identified as a poor performer with respect to another aspect of the work item.

In one embodiment, work item interactions between agents and customers are monitored to determine the proficiency of the agent to determine training needs and the potential for changing a particular skill of an agent from a non-primary skill to a primary skill. A system is provided that may automatically look for specific phrases and other linguistic techniques (e.g., syntactic structure, words and phrases, semantic analysis, etc.) to determine the skill level of an agent when using a language or talking about a specific topic.

Converting speech to text, and then performing the analysis on the test, removes certain elements found in the speech portion, for example excessive pauses may be removed, however, certain results may still be provided by analysis of a transcription. In written communications (e.g., email, text chat, social media, etc.), analyzing agent proficiency with the language through syntax, vocabulary, and semantics may help determine not only language proficiency but also topic proficiency (e.g., improper use of reboot, too lengthy descriptions for common problems, etc.).

Automatic evaluation of performance may be determined, in part, by mid-call abandons or media escalation. If agents are non-primary agents with respect to a language attribute, but customers still keep indicating the agent is not communicating effectively (e.g., “I don't understand,” “Can you repeat that,” etc.) then the agent's proficiency may downgraded. Similarly, the absence of such phrases may be used to a need to upgrade the agent's proficiency. Monitoring the occurrence of indicating phrases and seeing a decline in occurrence may then be used to change the level of proficiency of the agent and move them closer to being a “primary” for that skill

In another embodiment, an agent's skill level may be graduated. For example, an agent might have, with respect to a skill, a proficiency of 10%, 20%, etc. In other embodiments, an agent is either “skilled” or “not skilled.” In this context, an agent is “proficient enough” or “not proficient enough.”

Work items may have varying degrees of expertise required for the non-primary skill In one embodiment, a work item may be routed to provide the agent with a mix of work items, for example, some work items may have an attribute that is a “stretch” and be outside an agent's comfort zone with respect to a particular skill. Other work items may “softball” and expected to be well within the agent's comfort zone. Still others may be scattered on the boundary of the agent's proficiencies. Accordingly, embodiments are provided herein to produce a graduated reporting on each of the “ranges of proficiency.”

The varying degrees of difficulty may also be reported in the scoring. For example, an agent who fails to successfully process a “stretch” work item may have their proficiency score only marginally decreased if at all. In contrast, successfully processing a “stretch” work item may produce a more significant increase in a proficiency score. Conversely, an agent who fails to successfully process a “softball” work item may have their proficiency score greatly decreased, while successfully completing such a work item may only marginally increase or even maintain their proficiency score.

In one embodiment, a system is disclosed, comprising: a work assignment engine configured to select a work item from a number of work items, the work item associated with an attribute in accord with a previously determined test criterion; a routing engine configured to route the work item to an agent to be tested, the agent having a pre-test proficiency level of a skill, the skill being in accord with the attribute, the pre-test proficiency level being less than a threshold level; an evaluation engine configured to examine a metric associated with the processing of the work item by the agent and determine a post-test proficiency level of the agent associated with the attribute; and a reporting module configured to output the post-test proficiency level of the agent.

In another embodiment, a microprocessor is disclosed, comprising: a work assignment engine module configured to select a work item from a number of work items, the work item associated with an attribute in accord with a previously determined test criterion; a routing engine module configured to route the work item to an agent to be tested, the agent having a pre-test proficiency level of a skill, the skill being in accord with the attribute, the pre-test proficiency level being less than a threshold level; an evaluation engine module configured to examine a metric associated with the processing of the work item by the agent and determine a post-test proficiency level of the agent associated with the attribute; and a reporting module configured to output the post-test proficiency level of the agent.

In another embodiment, a non-transitory computer readable medium having instructions thereon that, when read by a computer, cause the computer to perform: selection of a work item from a number of work items, the work item associated with an attribute in accord with a previously determined test criterion; routing of the work item to an agent to be tested, the agent having a pre-test proficiency level of a skill, the skill being in accord with the attribute, the pre-test proficiency level being less than a threshold level; examining a metric associated with the processing of the work item by the agent and determining a post-test proficiency level of the agent associated with the attribute; and output the post-test proficiency level of the agent.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a communication system in accordance with embodiments of the present disclosure;

FIG. 2 depict a first view of an agent scoring in accordance with at least some embodiments of the present disclosure;

FIG. 3 depict a second view of an agent scoring in accordance with at least some embodiments of the present disclosure;

FIG. 4 depict a diagram in accordance with at least some embodiments of the present disclosure; and

FIG. 5 depicts a process in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

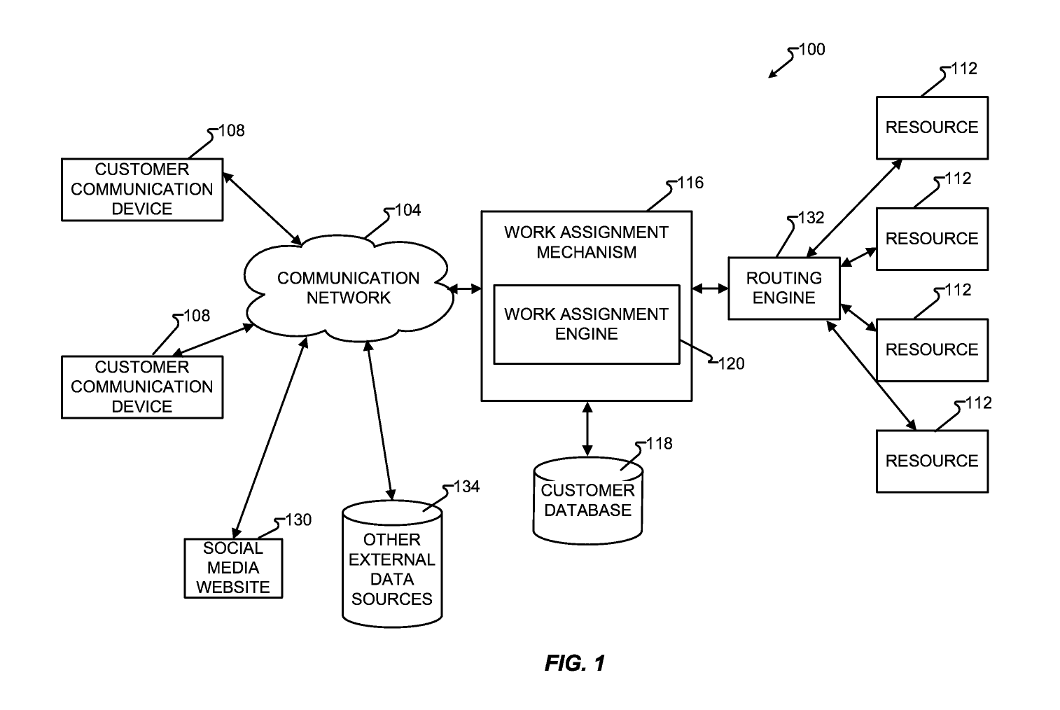

With reference now to FIG. 1, communication system 100 is now discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108. Additionally, social media website 130 and/or other external data sources 134 may be utilized to provide one means for a resource 112 to receive and/or retrieve contacts and connect to a customer of a contact center. Other external data sources 134 may include data sources such as service bureaus, third-party data providers (e.g., credit agencies, public and/or private records, etc.). Customers may utilize their respective customer communication device 108 to send/receive communications utilizing social media website 130.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to the contact center. Customer database 118 may be updated in response to a work item and/or input from resource 112 processing the work item.

In one embodiment, a message is generated by customer communication device 108 and received, via communication network 104, at work assignment mechanism 116. The message received by a contact center, such as at the work assignment mechanism 116, is generally, and herein, referred to as a “contact.” Routing engine 132 routes the contact to at least one of resources 112 for processing.

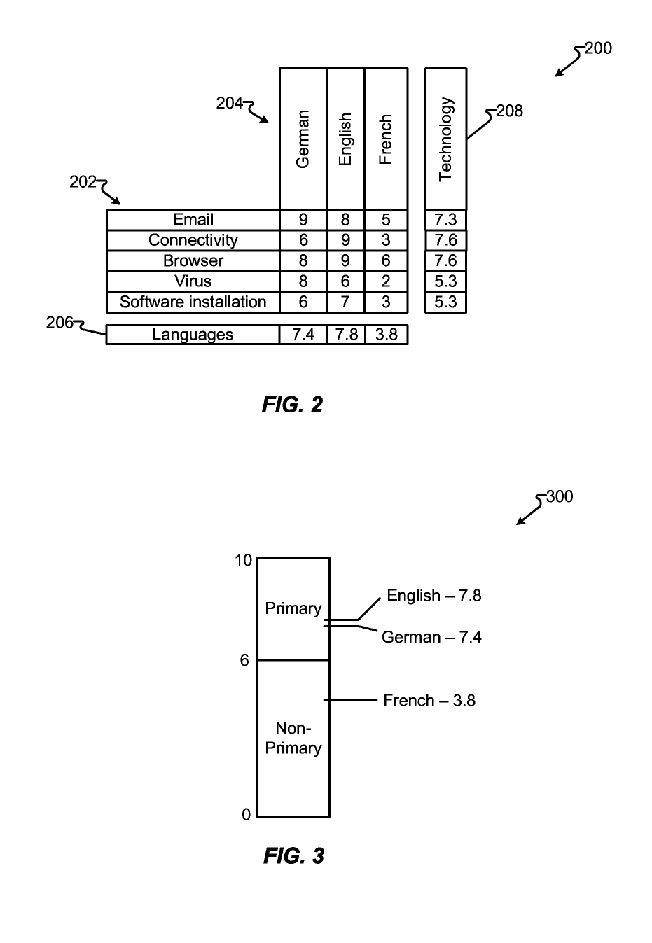

With reference now to FIG. 2 and FIG. 3, agent scoring is described in accordance with at least some embodiments of the present disclosure. In one embodiment, two-dimensional grid 200 comprises technology axis 202 and language axis 204. Summary language score 206 and summary technology score 208 provide a summary of the agent's skills for each language and each technology. A sufficient number of work items are processed by an agent and preferably the number of work items is a statistically significant number of work items for each category. However, for work items having an attribute associated with an agent skill, in which the agent is a non-primary agent, the number of non-primary work items may be significantly fewer than for work items for which the agent is a primary agent. For example, the agent may have technical expertise in various areas of computer operations and speak three languages with different levels of fluency. The number of work items the agent receives from German and English speaking customers, may be a nearly uninterrupted stream of work items. However, the agent may receive few, or even just one, work items associated with French speaking customers.

Grid 200 illustrates a two-dimensional grid whereby two areas of agent expertise may be scored and/or summarized. In other embodiments the grid may be multi-dimensional and may even have a great number of dimensions, such as to reflect a highly granular skill categorization and the agent's abilities within each category.

Grid 300 of FIG. 3 displays a summary of the agent skills with respect to language axis 204. In one embodiment, the division between a primary and non-primary skill level is “6” and the agent has certain skills above the primary skill level qualification (e.g., English and German) and one skill that is within the non-primary skill qualification (e.g., French).

The embodiments disclosed allow for an agent to be evaluated with respect to their non-primary skills without requiring a separate means and resources to evaluate agents. Often it is difficult to remove an agent from their assigned duties (e.g., primary work items) so that they can be evaluated with respect to their non-primary skills. At the other end of the spectrum, providing agents with non-primary work items, as if they were no different than primary work items, may cause frustration and other negative results on the part of the agent and the customers associated with the non-primary work items. An agent may process a non-primary work item more slowly than a work item for which the agent is a primary agent. However, the agent receiving the non-primary work item a frequency that allows the slower performance to be rendered inconsequential within the larger mix of primary work items may be more willing to accept non-primary work items.

Measurement of an agent's performance is variously embodied and includes, real-time and historic review, agent self-assessment, customer survey, supervisor scoring, etc. The scoring may be by human and/or automated systems. For example, certain key words or phrases may be detected by automated systems and indicate a performance aspect, whether it be a desired (e.g., positive) word or phrase (e.g., “I want to thank you for being one of our most loyal customers.”). or an undesired (e.g., negative) word or phrase (e.g., “Say that again,” “What do you mean?”, etc.). The word or phrase may be spoke by the customer or the agent. In another embodiment, the absence of a word or phrase may be utilized to score a work item. For example, the absence of the phrase, “I don't understand,” may be used to indicate a greater degree of skill than if the phrase were spoke.

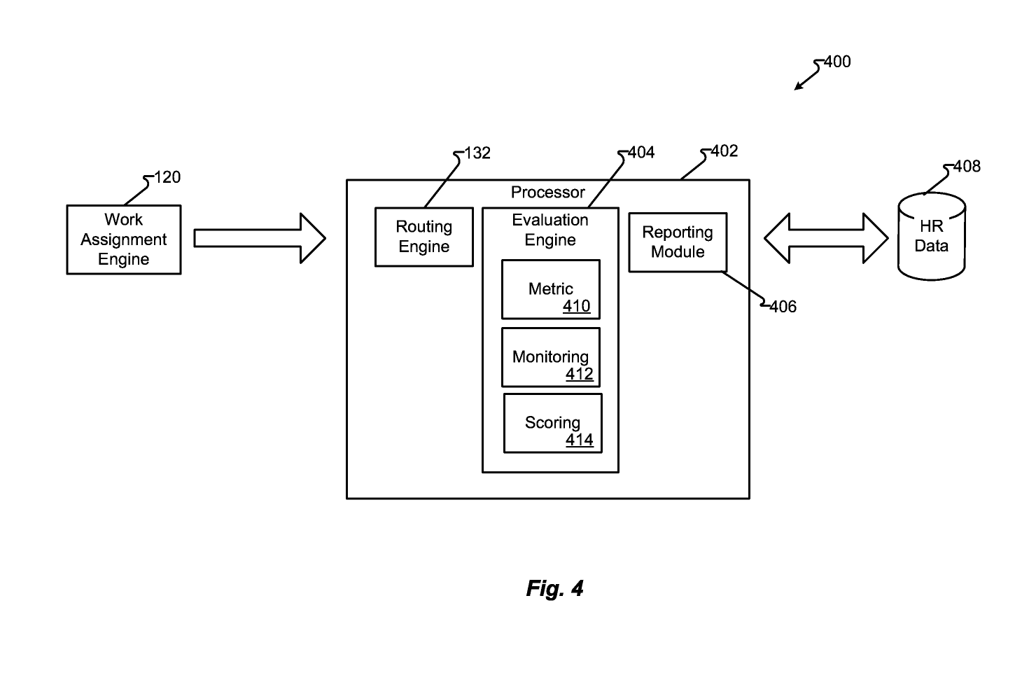

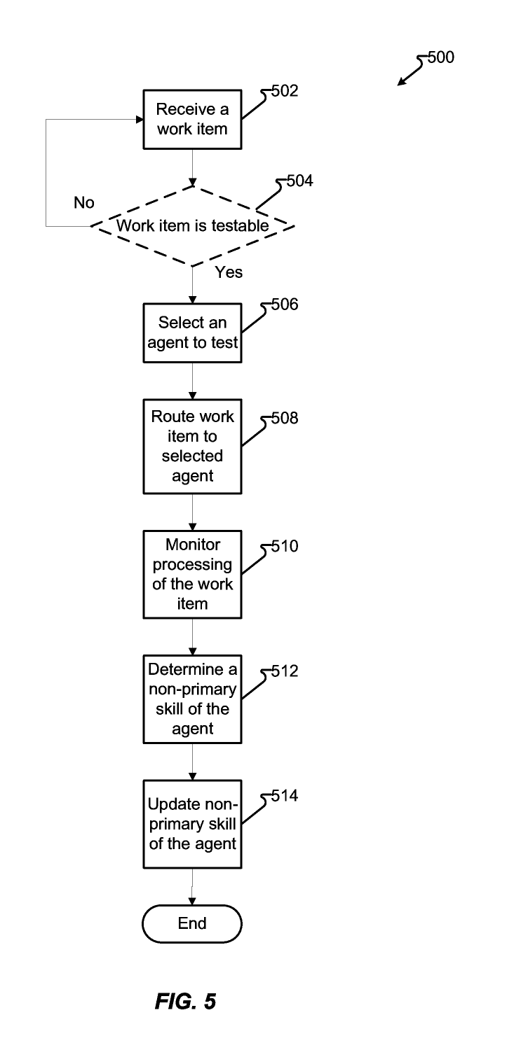

With reference now to FIG. 4, diagram 400 is described in accordance with at least some embodiments of the present disclosure. In one embodiment, processor 402 receives electronic input signals, such as via an I/O port, from work assignment engine 120, such as one or more work items. Processor 402 outputs electronic signals as a report, such as from an I/O port, to provide an update of an agent's performance score to human resource database 408. In other embodiments, reporting by processor 402 may be made available to the agent, supervisor, and/or other entity.

Routing engine 132 selects a work item to send to an agent. Routing engine 132 may further determine which agent receives a work item, or which work item to send to an agent, based upon the agent having a pre-evaluation proficiency that is below a threshold level. The threshold level may be the separation between the proficiency of the agent being categorized as primary or non-primary. For example, a contact center may wish to avoid the inefficiency of testing primary agents with respect to their primary skill or employ alternative testing of their proficient skills However, as disclosed herein, occasional spot-checking may be employed. This may be particularly useful if an agent is recently and/or marginally proficient to be a primary agent. In such an evaluation the threshold may be a previously defined threshold, such as the primary/non-primary division plus ten percent, primary for less than six months, etc.

The selection of an agent may be performed in conjunction with accessing human resource database 408, whereby an agent is selected for testing of a non-primary skill. Evaluation engine 404 determines a score, rank, or other attribute associated with the agent's performance in processing the work item. Evaluation engine 404 may maintain a plurality of scores such that an average, aged, summary, or other aggregated score for a plurality of work items may be provided. Evaluation engine 404 may comprise a number of subcomponents selected for one or more of the criterion selection (e.g., what is to be scored), how resource 112 is monitored, the monitoring of resource 112, and the scoring of resource 112.

Subcomponents of evaluation engine 404 may include metric 410. Metric 410 may represent the non-primary skill of the resource 112 to be tested. For example, if resource 112 is evaluated on their ability to communicate in spoken Spanish, router configurations, etc., then metric 410 may be selected in accord with the spoken Spanish language, the settings of at least one router, or other aspect. Monitoring 412 determines one or more data points for the evaluation of resource 112 and may be further selected in accord with metric 410. For example, if communication is to be tested, hearing a customer say, “I don't understand you” or “What are you trying to say” or the absence of such a phrase, may provide a data point as to the effectiveness of communication of resource 112 in the particular language.

In another example, if product knowledge is to be tested, then long pauses, assumedly to allow the agent to look-up information, may also be an indicator of poor product knowledge. In contrast, short pauses, or at least the absence of long pauses, may indicate greater product knowledge. The actual volume or number of lookups may also be utilized to determine product knowledge or lack thereof. For example, a text-based work item may not have any appreciable pauses, however, if the resource 112 is accessing product information repeatedly, then knowledge may be scored as deficient. Similarly, the lack of accessing product information may result in a higher product knowledge score.

Scoring 414 evaluates the data points. The specific scoring methodology may be a matter of design choice and selected in accord with one or more objectives of the contact center. For example, a pause of one to three seconds may be determined to be conversational and indicate good understanding and, therefore, scored minimally positive. Pauses of three to five seconds may be determined to be a neutral and scored neutrally. A small number of longer pauses may similarly be neutral and so scored. However, a single long pause, such as twenty seconds or more may be scored heavily negative, such as when a contact center has determined that such a long pause is serious failing. Storing 414 provides a score for the monitored work item by resource 112. Scoring may be binary (e.g, pass/fail), ranked (e.g., 7 out of 10, 79^{th} percentile, etc.), detailed (e.g., “paused too long,” “twice the customer indicated that the agent communicated effectively,” “repeated steps 3-6 with an alternative setting,” etc.), or other scoring means as maybe selected as a matter of design choice.

Reporting module 406 then provides the output of the agent's performance. Reporting module 406 may provide the output to HR database 408. Reporting module may also or alternatively report the output to the resource 112 under test, a supervisor of the resource 112, accounting personnel and/or systems (e.g., for determination of performance metrics), and/or human resource personnel.

Processor 402 may be variously configured and include one or more components of FIG. 1, such as work assignment engine 120 and even resource 112 (e.g., a human and/or automated agent). In other embodiments, processor 402 may be a plurality of processors in communication with each other. Examples of a suitable processor 402 include, without limitation, a microprocessor, an Integrated Circuit (IC) chip, a plurality of IC chips, etc.

With reference now to FIG. 5, process 500 is described in accordance with at least some embodiments of the present disclosure. In one embodiment, step 502 receives a work item. The work item may be received may be in-bound, and received by a customer initiating the work item, or out-bound, and received by the agent from a component of the contact center. The work item may be retrieved from social media website 130, such as when a customer posts a question. Posts on social media website 130 may or may not be work items and work assignment mechanism, and/or other component, may determine if a post does represent a work item. For example, post such as, “Who can I talk to about an error on my rewards program?” “You lost my luggage,” and “Where can I find the number for Dallas operations?” may or may not be an explicit request for help, but yet warrant a response as determined by company policy. Posts such as, “Here's a picture of the sunrise leaving Boston,” on the other hand, may not warrant a response and, therefore, not be a work item. Work items may be received via various other channels, such as text (instant message), email, video mail, and various forms of voice (e.g., VoIP, cellular, public switched telephone network, kiosk, etc.).

Optionally, step 504 determines if the work item is testable by a non-primary agent. For example, a customer associated with a previous work item selected for agent testing by a non-primary agent, may have subsequent work items routed to a primary agent and excluded from consideration from testing by a non-primary agent. After a certain amount of time has passed and/or a number of work items routed to primary agents, work items associated with the particular customer may again be considered for testing of non-primary agents. In another embodiment, certain subject matter, high-value customers, or other attributes may indicate that a work item is not to be used for tested and should only be sent to primary agents. If optional step 504 is determined to be no, the item may then be routed to a primary agent and process 500 continues back at step 502. If step 504 produces a yes, or if step 504 is omitted, processing continues to step 506. Step 506 selects an agent to test with the work item received in step 502.

Steps 504 and 506 may be as illustrated whereby a work item is determined to be testable in step 504 and then an agent is selected in step 506. Alternatively, an agent to be tested in step 506 is selected and then step 504 determines if a work item is testable by the selected agent from step 506. The later may be preferred, such as when the skill to be tested occurs rarely. For example, if an agent is to be evaluated on their ability to communicate in Icelandic, but Icelandic customers are only encountered infrequently, step 506 may select the agent and cause step 502 and 504 to continually monitor work items until an Icelandic work item is available to test the agent.

Step 508 routes the work item to the selected agent, step 510 monitors the agent's processing of the work item, and step 512 determines a skill metric for the non-primary skill One or both of steps 510 and 512 may be performed by evaluation engine 404. Steps 510 and 512 may incorporate human and/or automated means. The monitoring of step 510 and determination of step 512 may depend on the skill to be tested. For example, if the ability to communicate in a particular language is evaluated, then the customer's speech or text having, or not having, terms such as, “I don't understand,” “that doesn't make sense,” “say that again,” “you've been very helpful,” “that is clear,” etc. may be used, alone or in part, to determine the skill of the agent with respect to that particular language. If the skill to be evaluated is product knowledge, the presence or absence of terms, such as, “I'm not sure that's right,” “That isn't compatible,” “That's not what I wanted,” “That's what I needed,” may be used to determine the agent's product skill proficiency. In addition to specific words or phrases spoken, or typed, by the customer, works or phrases spoke by the agent may similarly be monitored by 510 and determined by step 512. For example, “Let's go back to step 3,” “That didn't work,” “Are you sure you tried turning it off and turning in on again?” and long pauses, or the absence thereof, may be monitored by step 510 and determine a skill proficiency by step 512.

With the non-primary skill determined by step 512, step 514 updates the non-primary skill of the agent. Step 514 may further report the skill to one or more of the agent, the agent's supervisor, human resource, statistical systems, compliance personnel and/or systems, and other parties.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary work items may be stored in a machine readable medium such as storage medium. A processor(s) may perform the necessary work items. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a work assignment engine configured to select a work item from a number of work items, the selected work item associated with an attribute in accord with a previously determined test criterion;
a routing engine configured to route the work item to an agent to be tested, the agent having a pre-test proficiency level of a skill, the skill being in accord with the attribute, the pre-test proficiency level being less than a threshold level;
an evaluation engine configured to examine a metric associated with the processing of the work item by the agent and determine a post-test proficiency level of the agent associated with the attribute; and
a reporting module configured to output the post-test proficiency level of the agent.

2. The system of claim 1, wherein the threshold level is a previously determined proficiency level.

3. The system of claim 1, wherein the agent is selected from a pool of agents each having a pre-test proficiency level below the threshold level.

4. The system of claim 1, further comprising:
a database; and
wherein the reporting module causes a record of the database associated with the agent to be updated in accord with the post-test proficiency level.

5. The system of claim 1, wherein the agent has pre-test proficiency level that is at least a minimum competency level.

6. The system of claim 1, wherein:
the work assignment engine selects a plurality of work items each having the attribute and at least one of a plurality of other attributes excluding the attribute;
the routing engine routes the plurality of work items to the agent; and
the evaluation engine examines the metric associated with the processing of the plurality of work items by the agent and determines the post-test proficiency level of the agent associated with the attribute and substantially excluding the other attributes.

7. The system of claim 1, wherein the routing engine is configured to, upon determining the work item is identified as having a high importance, route the work item to a primary agent and not to the agent.

8. The system of claim 1, wherein the evaluation engine examines the metric associated with a customer, associated with the work item being processed by the agent, expressing a lack of proficiency by the agent.

9. The system of claim 1, wherein the evaluation engine examines the metric associated with a customer, associated with the work item being processed by the agent, omitting any expression of a lack of proficiency by the agent.

10. A microprocessor with processing modules, the processing modules comprising:
a work assignment engine module configured to select a work item from a number of work items, the work item associated with an attribute in accord with a previously determined test criterion;
a routing engine module configured to route the work item to an agent to be tested, the agent having a pre-test proficiency level of a skill, the skill being in accord with the attribute, the pre-test proficiency level being less than a threshold level;
an evaluation engine module configured to examine a metric associated with the processing of the work item by the agent and determine a post-test proficiency level of the agent associated with the attribute; and
a reporting module configured to output the post-test proficiency level of the agent.

11. The microprocessor of claim 10, wherein:
the work assignment engine module selects a plurality of work items each having the attribute and at least one of a plurality of other attributes excluding the attribute;
the routing engine module routes the plurality of work items to the agent; and
the evaluation module engine examines the metric associated with the processing of the plurality of work items by the agent and determines the post-test proficiency level of the agent associated with the attribute and substantially excluding the other attributes.

12. The microprocessor of claim 10, wherein the agent is selected from a pool of agents each having a pre-test proficiency level below the threshold level.

13. The microprocessor of claim 10, wherein the routing engine module is configured to, upon determining the work item is identified as having a high importance, route the work item to a primary agent and not to the agent.

14. The microprocessor of claim 10, wherein the evaluation engine module examines the metric associated with a customer, associated with the work item being processed by the agent, expressing a lack of proficiency by the agent.

15. The microprocessor of claim 10, wherein the evaluation engine module examines the metric associated with a customer, associated with the work item being processed by the agent, omitting any expression of a lack of proficiency by the agent.

16. A non-transitory computer readable medium having instructions thereon that, when read by a computer, cause the computer to perform:
selection of a work item from a number of work items, the work item associated with an attribute in accord with a previously determined test criterion;
routing of the work item to an agent to be tested, the agent having a pre-test proficiency level of a skill, the skill being in accord with the attribute, the pre-test proficiency level being less than a threshold level;
examining a metric associated with the processing of the work item by the agent and determining a post-test proficiency level of the agent associated with the attribute; and
output the post-test proficiency level of the agent.

17. The instructions of claim 16, wherein the threshold level is a proficiency level.

18. The instructions of claim 16, wherein the agent is selected from a pool of agents each having a pre-test proficiency level below the threshold level.

19. The instructions of claim 16, further comprising: instructions to identify the work item as having a high important and routing to a primary agent and not routing the work item to the agent.

20. The instructions of claim 16, wherein the agent has pre-test proficiency level that is at least a minimum competency level.
